(19) United States
(12) Patent Application Publication
(10) Pub. No.: US 2009/0134532 A1
(43) Pub. Date: May 28, 2009

(54) Aerating device for aquarium

(76) Inventor: Hsueh Lee Tsai, Yunlin Hsien (TW)

Correspondence Address: CHARLES E. BAXLEY, ESQUIRE, 90 JOHN STREET, SUITE 309, NEW YORK, NY, 10038, US

(21) Appl. No.: 11/986,724

(22) Filed: Nov. 26, 2007

(51) Int. Cl. A01K 63/04; C02F 1/74; B01F 3/04

(52) U.S. Cl. 261/28; 210/167.26; 119/263

(57) ABSTRACT

A water aerating device for an aquarium includes a carrier, a pumping device attached to the carrier and having a motorized impeller for pumping a water, a siphon tube coupled to the pumping device and having a tube member engaged into the aquarium for allowing the water to be drawn into the siphon tube and drawn into the carrier by the impeller, and a number of rods disposed in the carrier for agitating the water and for minimizing an air contained in the water into smaller air bubbles. One or more air minimizing devices or helical spring members may further agitate the water and minimize the air contained in the water for supplying the reduced air bubbles to the water plants or the water weeds.

### BACKGROUND OF THE INVENTION

1. Field of the Invention

The present invention relates to a water aerating device for an aquarium, and more particularly to a water aerating device for attaching to an aquarium and for suitably supplying the carbon dioxide and/or the air into the water contained within the container and for suitably supplying the carbon dioxide and/or the air to the water plants or the water weeds received in the container.

2. Description of the Prior Art

Typical aquarium facilities comprise a pump disposed in a chamber of a container for circulating the water contained within the container and for pumping fresh air or carbon dioxide into the container and thus for airing or aerating purposes.

For example, U.S. Pat. No. 7,011,748 to Tsai discloses one of the typical aquariums having an air pumping device and comprising a paddle wheel disposed in a chamber of a container and arranged for impelling the water, and fresh air or carbon dioxide selectively pumped into the container.

However, the air pumping device may only be used to supply the air into the water that is received within the container, but may not be used to suitably minimize and supply the carbon dioxide and/or the air into the water contained within the container and also may not suitably supply the carbon dioxide and/or the air to the water plants or the water weeds received in the container. The present invention has arisen to mitigate and/or obviate the afore-described disadvantages of the conventional water aerating assemblies for aquarium facilities.

### SUMMARY OF THE INVENTION

The primary objective of the present invention is to provide a water aerating device for attaching to an aquarium for suitably supplying the carbon dioxide and/or the air into the water contained within the container and for suitably supplying the carbon dioxide and/or the air to the water plants or the water weeds received in the container.

The other objective of the present invention is to provide a water aerating device for minimizing and supplying the carbon dioxide and/or the fresh air into the water and for allowing the air and/or the carbon dioxide and/or the oxygen to be suitably supplied to the water plants or the water weeds received in the container.

In accordance with one aspect of the invention, there is provided a water aerating device for an aquarium comprising a carrier for attaching to a container of the aquarium and including a compartment formed therein, a pumping device attached to the carrier and including a motorized impeller arranged in the compartment of the carrier for pumping and impelling a water received in the container, a siphon tube including a first tube member coupled to the pumping device, and including a second tube member engaged into the container for allowing the water in the container to be drawn into the siphon tube and drawn into the compartment of the carrier by the motorized impeller, and a number of rods disposed in the compartment of the carrier for agitating the water pumped by the motorized impeller and for minimizing an air contained in the water into smaller air bubbles.

The pumping device includes a mouth, the motorized impeller is disposed in the mouth for pumping the water. The pumping device includes a barrel attached to the mouth of the pumping device and coupled to the first tube member of the siphon tube.

The pumping device includes at least one aperture formed in the mouth for allowing the water pumped by the motorized impeller to flow out through the aperture of the mouth and to flow into the compartment of the carrier.

The siphon tube includes a conduit engaged into the first tube member of the siphon tube for directing the air into the siphon tube. The siphon tube includes a valve device attached to the siphon tube and coupled to the conduit and having an entrance for allowing the air to flow into the valve device and the conduit. The siphon tube includes a valve member attached to the valve device for controlling the air into the valve device.

The siphon tube includes an outlet member attached to the conduit and having a perforation formed therein and communicating with the first tube member of the siphon tube. The outlet member includes an outer peripheral flange extended outwardly therefrom for engaging with and for agitating the water drawn by the pumping device.

A board is further provided and engaged into the carrier and disposed on the compartment of the carrier for closing the compartment of the carrier. The rods are extended from the board. The board includes an outlet port formed therein, and a dirt collecting device includes a receptacle coupled to the outlet port of the board.

The receptacle includes a tube disposed in the receptacle and disposed on the pumping device for forming an annular space between the receptacle and the tube and for receiving the water pumped by the impeller. The tube includes at least one protrusion extended outwardly from the tube for agitating the water flowing into the annular space of the receptacle and for generating an eddy current.

The receptacle includes a tubular member extended in an upper portion of the receptacle for forming an annular chamber between the tubular member and the receptacle, and for forming a chamber in the tubular member which is communicating with the annular space between the receptacle and the tube for allowing the air bubbles to flow upwardly through the annular space between the receptacle and the tube and the chamber of the tubular member.

The receptacle includes a cover disposed on top thereof and having a number of orifices formed therein for allowing the air to flow into the receptacle.

One or more air minimizing devices are further provided and disposed in the compartment of the carrier. The air minimizing devices are helical spring members.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a water aerating device for attaching to an aquarium in accordance with the present invention;

FIG. 2 is a partial exploded view of the water aerating device;

FIG. 3 is a partial cross sectional view of the water aerating device taken along lines 3-3 of FIG. 1;

FIG. 4 is a cross sectional view taken along lines 4-4 of FIG. 1;

FIG. 5 is a perspective view similar to FIG. 1, illustrating the other arrangement of the water aerating device;

FIG. 6 is a partial exploded view of the water aerating device as shown in FIG. 5;

FIG. 7 is a partial cross sectional view of the water aerating device taken along lines 7-7 of FIG. 5; and

FIG. 8 is a partial top plan schematic view illustrating the operation of the water aerating device as shown in FIGS. 5-7..

### DETAILED DESCRIPTION OF THE PREFERRED EMBODIMENT

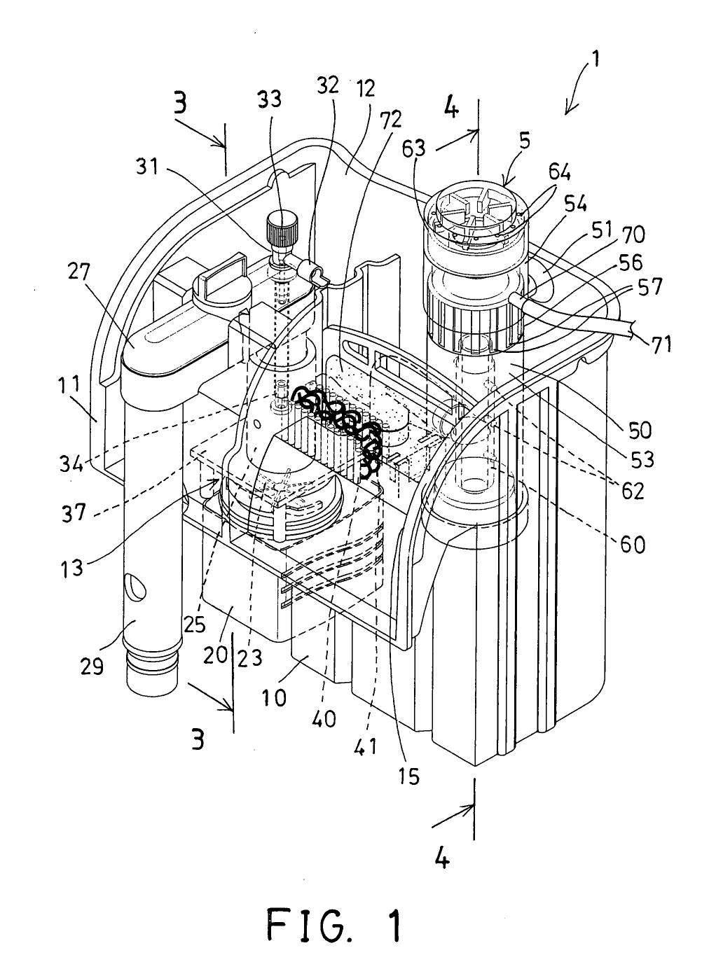

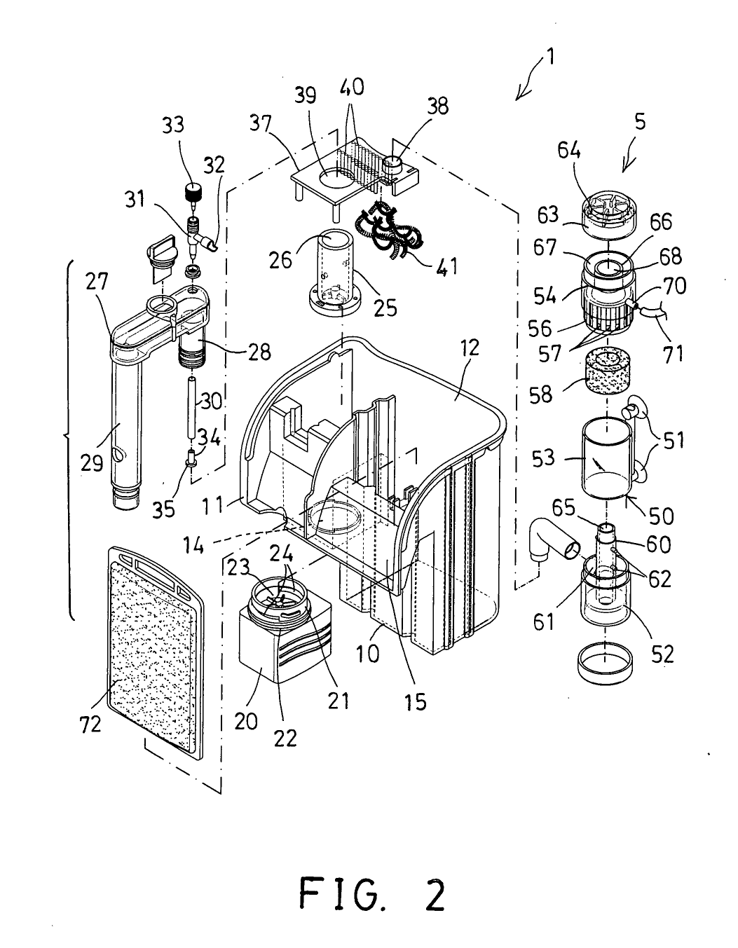

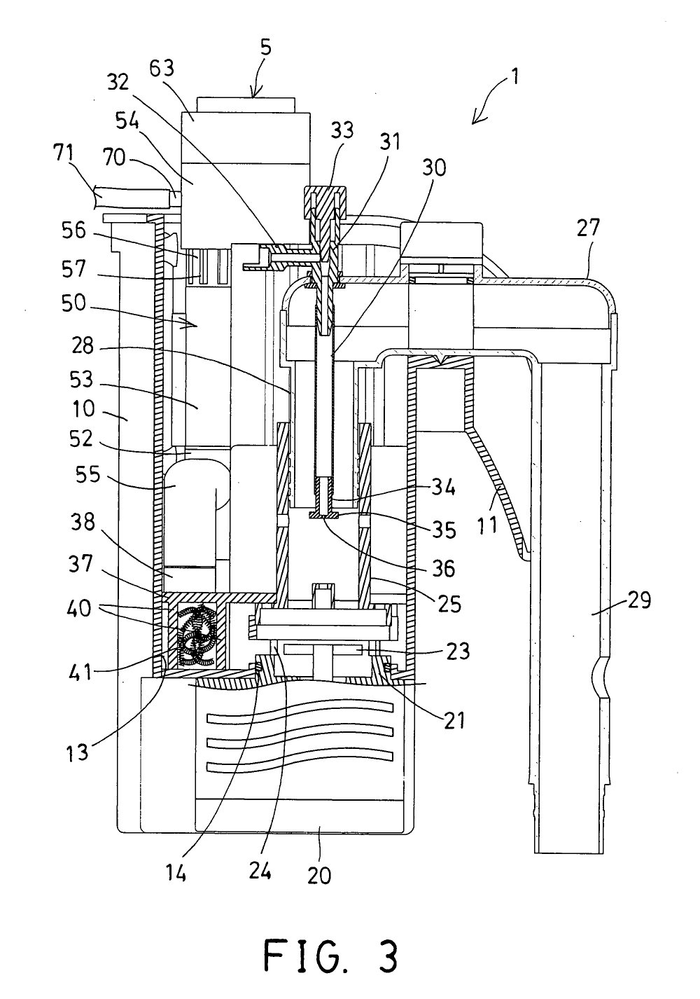

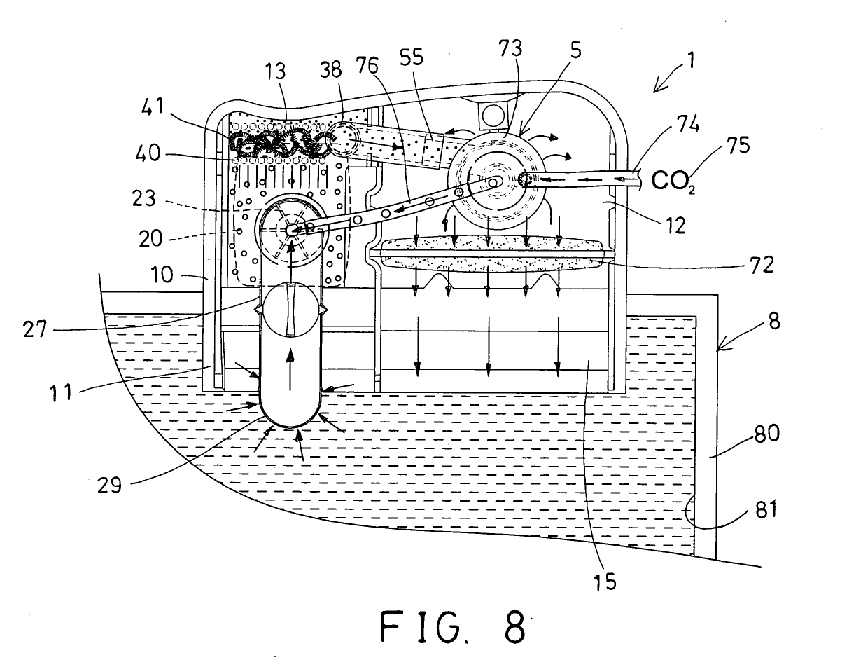

Referring to the drawings, and initially to FIGS. 1-4, a water aerating device in accordance with the present invention comprises an aerating device 1 for attaching to an aquarium 8 (FIG. 8) which comprises a container 80 including a chamber 81 formed therein for receiving water and fish, and includes a carrier 10 having a hook or attaching means or device 11 for readily attaching to the wall or the outer portion of the container 80 without hooks or latches or fasteners or sucking cups or the like, the carrier 10 includes a chamber 12 formed therein, and includes a compartment 13 formed therein, and includes an opening 14 formed therein (FIGS. 2, 3) and communicating with the compartment 13 of the carrier 10.

A pumping device 20 includes a mouth 21 for engaging through the opening 14 of the carrier 10 and for engaging into the compartment 13 of the carrier 10 and for attaching or securing to the carrier 10 with such as latches or fasteners (not shown) or a threading engagement 22, and includes a powered or motorized impeller 23 disposed or arranged in the mouth 21 for pumping or impelling the water, and includes one or more apertures 24 formed in the mouth 21 for allowing the water to be pumped or impelled by the powered or motorized impeller 23 and to flow out through the apertures 24 of the mouth 21 or of the pumping device 20, and then to flow into the compartment 13 of the carrier 10.

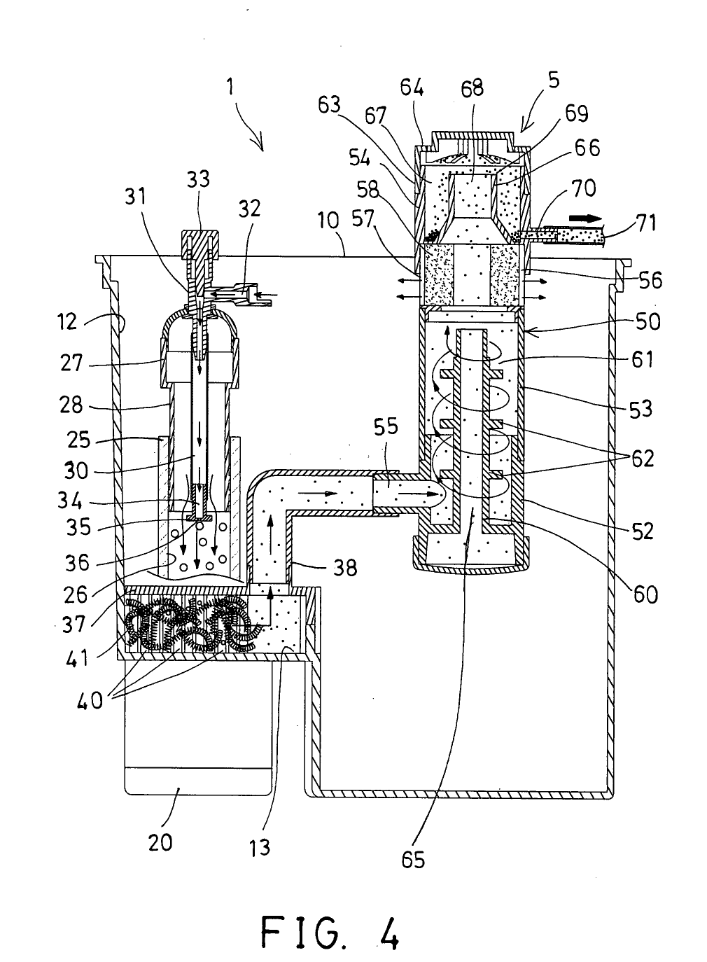

A barrel 25 is disposed or attached onto the mouth 21 of the pumping device 20, and includes a bore 26 formed therein for coupling to a siphon tube 27 which includes a first tube member 28 engaged into or secured or coupling to the barrel 25 of the pumping device 20, and includes a second tube member 29 extended out of the carrier 10 (FIG. 1) and engaged into the chamber 81 of the container 80 (FIG. 8) for allowing the water in the chamber 81 of the container 80 to be drawn into the tube members 28, 29 of the siphon tube 27 (FIG. 8) and then drawn into the barrel 25 of the pumping device 20 (FIG. 4) by the powered or motorized impeller 23, and to flow out through the apertures 24 of the pumping device 20 (FIG. 3) and then to flow into the compartment 13 of the carrier 10.

A conduit 30 is disposed or engaged into the siphon tube 27, such as the first tube member 28 of the siphon tube 27, and a valve device 31 is attached to the siphon tube 27 and coupled to the conduit 30 and includes an entrance 32 for allowing the air to flow into the valve device 31 and the conduit 30 and then to be drawn into the barrel 25 of the pumping device 20 (FIG. 4) by the powered or motorized impeller 23. A valve member 33 may be attached to the valve device 31 for controlling the valve device 31 and for determining the flowing quantity and/or the flowing speed of the air into the valve device 31 and then into the water that is drawn by the powered or motorized impeller 23.

An outlet member 34 is attached to the lower portion of the conduit 30 and includes an outer peripheral flange 35 extended outwardly therefrom for engaging with or for agitating the water drawn into the barrel 25 of the pumping device 20 (FIG. 4), and includes a perforation 36 formed therein (FIGS. 3, 4) and communicating with the first tube member 28 of the siphon tube 27 and the bore 26 of the barrel 25 for allowing the air to be drawn into the bore 26 of the barrel 25. It is to be noted that the fresh air in the outer environment may be supplied or drawn into the entrance 32 of the valve device 31, or an air or gas reservoir (not shown) may be coupled to the entrance 32 of the valve device 31 for supplying the air and/or the gas into the valve device 31.

The carrier 10 includes a board 37 engaged into the chamber 12 of the carrier 10 and disposed on the upper portion of the compartment 13 of the carrier 10 for closing the compartment 13 of the carrier 10, and includes an outlet port 38 formed therein, and includes a hole 39 formed therein for receiving or engaging with the barrel 25, a number of posts or rods 40 are provided and disposed in the compartment 13 of the carrier 10, such as extended from the board 37 and disposed between the barrel 25 and/or the mouth 21 and the outlet port 38 of the board 37 or of the carrier 10 for agitating the water and the air and/or the gas pumped or drawn by the powered or motorized impeller 23 and for minimizing or reducing the size or dimension or diameter of the air and/or the gas (FIGS. 3, 4).

One or more air or gas minimizing devices 41, such as helical spring members 41 are disposed in the compartment 13 of the carrier 10, and preferably disposed or engaged between the rods 40 for further engaging with the water and the air and/or the gas and for further agitating the water and the air and/or the gas and for further minimizing or reducing the size or dimension or diameter of the air and/or the gas (FIGS. 3, 4), and arranged for allowing the minimized or reduced air or gas to be suitably mixed or blended with the water and then to flow into the chamber 81 of the container 80 and then to be suitably supplied to the water plants or the water weeds received in the container 80.

A dirt collecting means or device 5 includes a receptacle 50 to be attached or secured to the interior of the carrier 10 with hooks or latches or fasteners (not shown) or sucking cups 51 or the like, the receptacle 50 may include one or more housing members 52, 53, 54 assembled or secured or coupled together with such as force-fitted engagements, hooks or latches or fasteners (not shown) or with adhesive materials, or by welding processes, and may include an inlet port 55 coupled to the outlet port 38 of the board 37 or of the carrier 10 for receiving the water and the minimized or reduced air or gas pumped or drawn or propelled by the powered or motorized impeller 23.

The receptacle 50 may include a screen or an outlet member 56 such as disposed between and secured to the housing members 53, 54 with such as force-fitted engagements, hooks or latches or fasteners (not shown) or with adhesive materials, or by welding processes, and having a number of orifices 57 formed therein (FIG. 3) for allowing the water in the receptacle 50 to flow out through the orifices 57 of the outlet member 56 of the receptacle 50 (FIG. 4). A filter sponge or member 58 may be disposed in the upper housing member 54 and aligned with the orifices 57 of the outlet member 56 or of the receptacle 50 for filtering the water and for separating the dirt or the protein from the water and thus for preventing the filtered dirt or protein from flowing into the chamber 81 of the container 80 again.

The receptacle 50 may include a tube 60, such as a hollow tube 60 disposed or extended therein, such as disposed concentrically in the receptacle 50 and disposed or extended within such as the housing members 52, 53, for forming an annular space 61 between the receptacle 50 and the tube 60 (FIG. 4), and includes one or more protrusions 62 extended outwardly from the tube 60 for agitating the water and for forming or generating an eddy current (FIG. 4), and thus for suitably agitating the water and the carbon dioxide and/or the air and/or the gas contained within the water in order to suitably agitate or to minimize the carbon dioxide and/or the air and/or the gas into a large amount of smaller air bubbles. The receptacle 50 may include a cover 63 disposed on top thereof and having a number of orifices 64 formed therein for allowing the air in the environment to flow into the receptacle 50. The tube 60 includes a bore 65 formed therein.

The receptacle 50 includes a tubular member 66 extended in such as the upper portion thereof or the upper housing member 54 for forming an annular chamber 67 between the tubular member 66 and the upper housing member 54, and for forming a chamber 68 within the tubular member 66 and communicating with the annular space 61 between the receptacle 50 and the tube 60 and allowing the water and the carbon dioxide and/or the air and/or the gas to flow upwardly through the chamber 68 of the tubular member 66. As shown in FIG. 4, the upper portion of the tubular member 66 is slightly lower than the upper portion of the receptacle 50 and/or slightly lower than the cover 63 for forming a space or a gap 69 between the tubular member 66 and the cover 63.

The air bubbles or the air and/or the carbon dioxide and/or the gas in the annular space 61 between the receptacle 50 and the tube 60 may flow upwardly through the chamber 68 of the tubular member 66 and may carry the dirt and/or the protein contained in the water for moving the dirt and/or the protein upwardly through the chamber 68 of the tubular member 66 and then for moving the dirt and/or the protein over the tubular member 66 and thus for moving the dirt and/or the protein through the gap 69 between the tubular member 66 and the cover 63 and into the annular chamber 67 of the upper housing member 54 or of the receptacle 50 and thus for allowing the dirt and/or the protein to be collected within the annular chamber 67 of the upper housing member 54 or of the receptacle 50.

The receptacle 50 may include an exit or outlet port 70 formed or provided in such as the upper portion thereof or the upper housing member 54 and communicating with the annular chamber 67 of the upper housing member 54, and coupled to a hose 71 for allowing the dirt and/or the protein to be drawn out of the annular chamber 67 of the upper housing member 54, and to be drawn into a dirt collector (not shown). The dirt or protein filtered by the filter sponge or member 58 may be separated from the water, and the filtered water may flow into the chamber 81 of the container 80 through the filter sponge or member 58 to prevent the filtered dirt or protein from flowing into the chamber 81 of the container 80 again. Another filter sponge or member 72 (FIGS. 1, 2, 8) may further be provided and disposed in front of an outlet opening 15 for further filtering the water.

In operation, the water in the container 80 may be drawn into the tube members 28, 29 of the siphon tube 27 and then drawn into the barrel 25 of the pumping device 20 by the powered or motorized impeller 23, and to flow out through the apertures 24 of the pumping device 20 (FIG. 3) and then to flow into the compartment 13 of the carrier 10, the fresh air in the outer environment may be supplied or drawn into the entrance 32 of the valve device 31 and then into the conduit 30 and then into the water drawn by the powered or motorized impeller 23, and the water and the air and/or the gas may be forced to flow through the rods 40 and the air or gas minimizing devices 41 or helical spring members 41 for further engaging with the water and the air and/or the gas and for further agitating and minimizing or reducing the size or dimension or diameter of the air and/or the gas.

The minimized or reduced air or gas may then be suitably mixed or blended with the water and then may flow into the annular space 61 between the receptacle 50 and the tube 60, and may further be agitated by the protrusions 62 of the tube 60 and then may flow upwardly through the chamber 68 of the tubular member 66 and may carry the dirt and/or the protein contained in the water for moving the dirt and/or the protein upwardly through the chamber 68 of the tubular member 66 and then for moving the dirt and/or the protein over the tubular member 66 and thus for allowing the dirt and/or the protein to be collected within the annular chamber 67 of the upper housing member 54 or of the receptacle 50 and thus for allowing the dirt and/or the protein to be easily drawn out of the annular chamber 67 of the upper housing member 54.

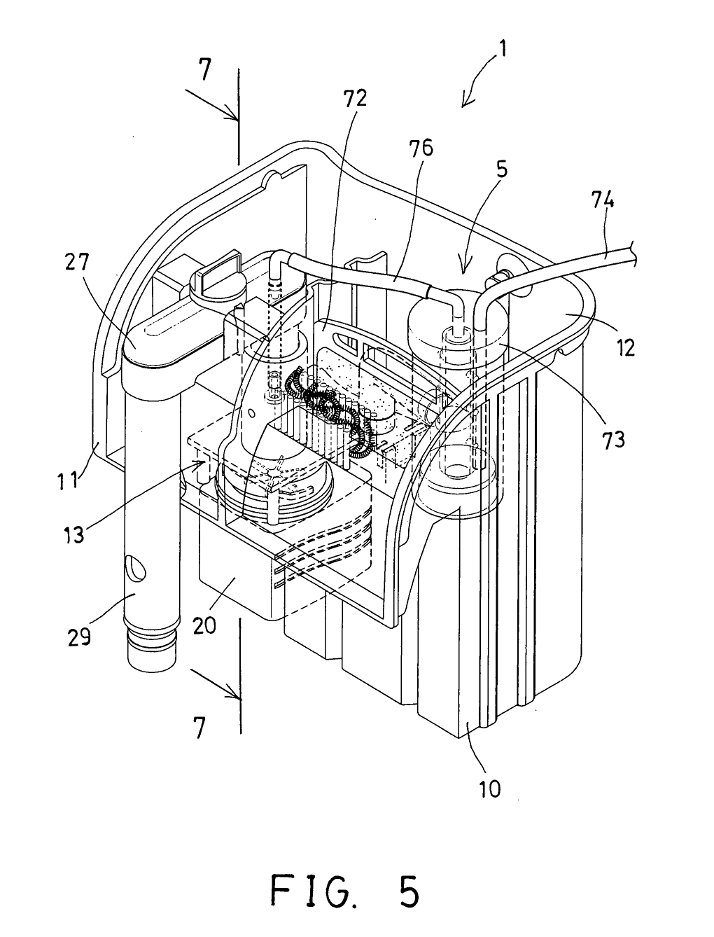

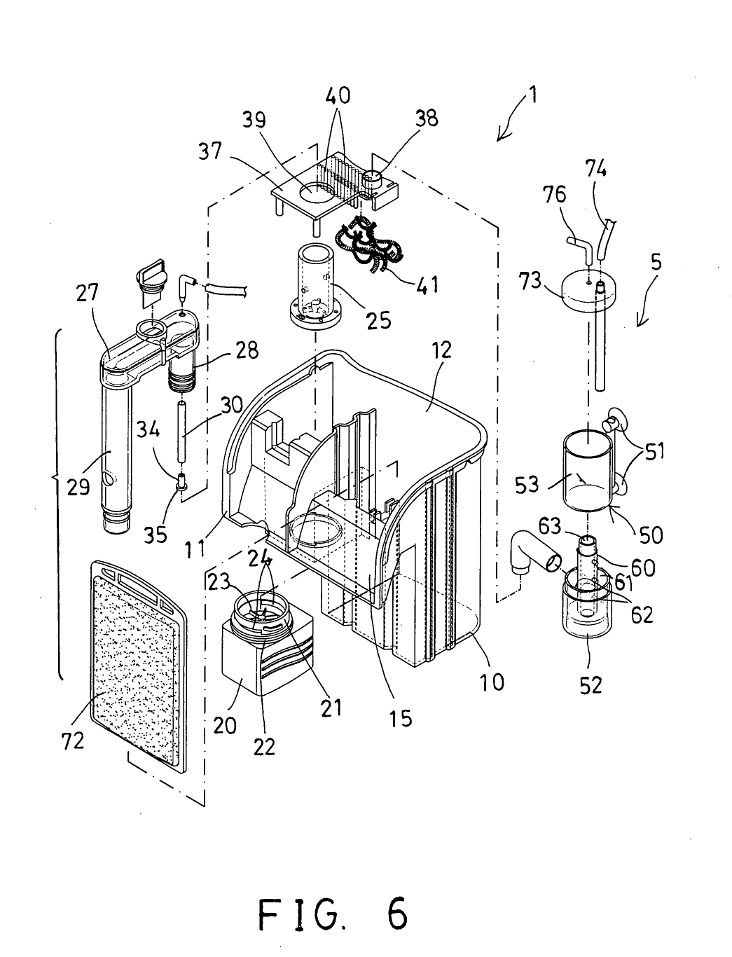

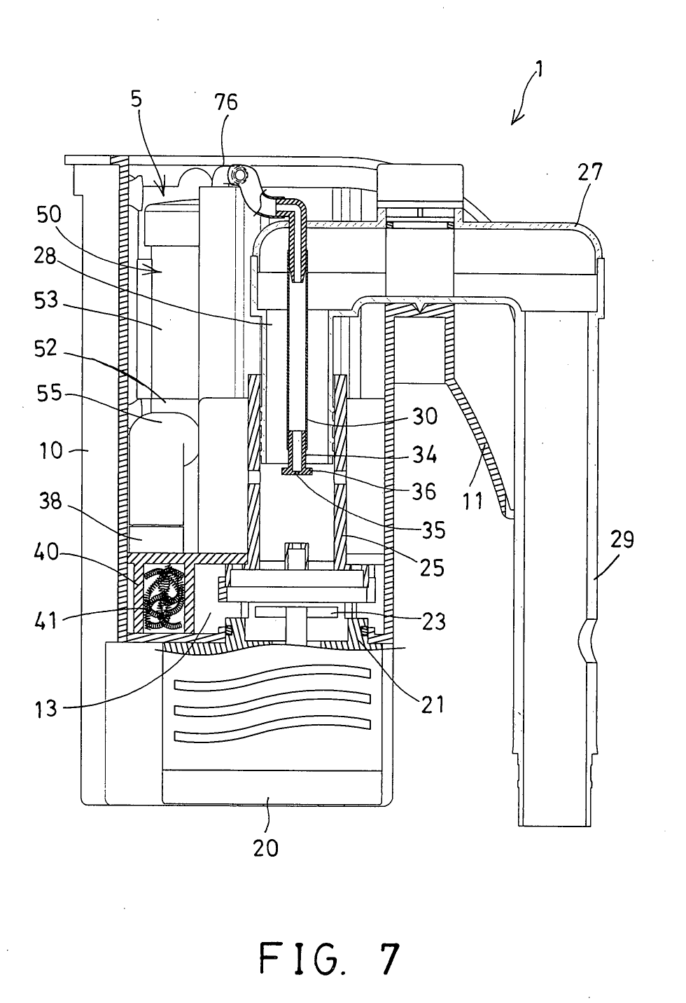

As shown in FIGS. 5-8, the dirt collecting means or device 5 may further include a cover 73 selectively or changeably disposed on top of the housing member 53, for replacing the cover 63 when the cover 63 is disengaged or removed from the receptacle 50, and includes a duct 74 coupled to a carbon dioxide or gas reservoir 75 for supplying the carbon dioxide and/or the gas into the receptacle 50, and includes a pipe 76 coupled to the conduit 30 for allowing the carbon dioxide and/or the gas to be recycled and to be supplied into the conduit 30, and thus for allowing the carbon dioxide and/or the gas further to be agitated or minimized or reduced into a large amount of smaller air bubbles.

Accordingly, the water aerating device in accordance with the present invention may be provided for attaching to an aquarium and for suitably agitating the water and the carbon dioxide and/or the air and for suitably supplying the carbon dioxide into the water contained within the container and for suitably supplying the carbon dioxide and/or the air to the water plants or the water weeds received in the container, and/or for minimizing and supplying the reduced carbon dioxide and/or the fresh air to the water plants or the water weeds received in the container.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A water aerating device for an aquarium comprising:
a carrier for attaching to a container of the aquarium and including a compartment formed therein,
a pumping device attached to the carrier and including a motorized impeller arranged in said compartment of said carrier for pumping and impelling a water received in the container,
a siphon tube including a first tube member coupled to said pumping device, and including a second tube member engaged into the container for allowing the water in the container to be drawn into said siphon tube and drawn into said compartment of said carrier by said motorized impeller, and
a plurality of rods disposed in said compartment of said carrier for agitating the water pumped by said motorized impeller and for minimizing an air contained in the water into smaller air bubbles.

2. The water aerating device as claimed in claim 1, wherein said pumping device includes a mouth, said motorized impeller is disposed in said mouth for pumping the water.

3. The water aerating device as claimed in claim 2, wherein said pumping device includes at least one aperture formed in said mouth for allowing the water pumped by said motorized impeller to flow out through said at least one aperture of said mouth and to flow into said compartment of said carrier.

4. The water aerating device as claimed in claim 2, wherein said pumping device includes a barrel attached to said mouth of said pumping device and coupled to said first tube member of said siphon tube.

5. The water aerating device as claimed in claim 1, wherein said siphon tube includes a conduit engaged into said first tube member of said siphon tube for directing the air into said siphon tube.

6. The water aerating device as claimed in claim 5, wherein said siphon tube includes a valve device attached to said siphon tube and coupled to said conduit and having an entrance for allowing the air to flow into said valve device and said conduit.

7. The water aerating device as claimed in claim 6, wherein said siphon tube includes a valve member attached to said valve device for controlling the air into said valve device.

8. The water aerating device as claimed in claim 5, wherein said siphon tube includes an outlet member attached to the conduit and having a perforation formed therein and communicating with said first tube member of said siphon tube.

9. The water aerating device as claimed in claim 8, wherein said outlet member includes an outer peripheral flange extended outwardly therefrom for engaging with and for agitating the water drawn by said pumping device.

10. The water aerating device as claimed in claim 1, wherein a board is engaged into said carrier and disposed on said compartment of said carrier for closing said compartment of said carrier.

11. The water aerating device as claimed in claim 10, wherein said rods are extended from said board.

12. The water aerating device as claimed in claim 10, wherein said board includes an outlet port formed therein, and a dirt collecting device includes a receptacle coupled to said outlet port of said board.

13. The water aerating device as claimed in claim 12, wherein said receptacle includes a tube disposed in said receptacle and disposed on said pumping device for forming an annular space between said receptacle and said tube and for receiving the water pumped by said impeller.

14. The water aerating device as claimed in claim 13, wherein said tube includes at least one protrusion extended outwardly from said tube for agitating the water flowing into said annular space of said receptacle and for generating an eddy current.

15. The water aerating device as claimed in claim 12, wherein said receptacle includes a tubular member extended in an upper portion of said receptacle for forming an annular chamber between said tubular member and said receptacle, and for forming a chamber in said tubular member which is communicating with said annular space between said receptacle and said tube for allowing the air bubbles to flow upwardly through said annular space between said receptacle and said tube and said chamber of said tubular member.

16. The water aerating device as claimed in claim 12, wherein said receptacle includes a cover disposed on top thereof and having a plurality of orifices formed therein for allowing the air to flow into said receptacle.

17. The water aerating device as claimed in claim 1, wherein at least one air minimizing device is disposed in said compartment of said carrier.

18. The water aerating device as claimed in claim 17, wherein said at least one air minimizing device is a helical spring member.
